(19) United States
(12) Patent Application Publication
(10) Pub. No.: US 2025/0224975 A1
(43) Pub. Date: Jul. 10, 2025

(54) OPTIMIZING DIRTY PAGE COPYING FOR A WORKLOAD RECEIVED DURING LIVE MIGRATION THAT MAKES USE OF HARDWARE ACCELERATOR VIRTUALIZATION

(71) Applicant: Intel Corporation, Santa Clara, CA (US)

(72) Inventors: Zhi Wang, Helsinki (FI); Yongwei XU, Shanghai (CN)

(73) Assignee: Intel Corporation, Santa Clara, CA (US)

(21) Appl. No.: 18/853,468

(22) PCT Filed: May 27, 2022
(86) PCT No.: PCT/CN2022/095538

§ 371 Date: Oct. 2, 2024

(51) Int. Cl. G06F 9/455

(52) U.S. Cl. CPC G06F 9/45558; G06F 2009/4557

(57) ABSTRACT

Embodiments described herein are generally directed to an improved workload submission handling strategy for workloads received during live migration and targeting VFs of a hardware accelerator. In an example, while performing a live migration of a source VM running on a source host to a destination VM of a destination host, a new workload targeting a VF of a first HW accelerator of the source host is identified by a HW status manager of the source host by trapping the workload submission channel. Based on a nature of the new workload, the HW status manager determines whether to transfer the new workload to the destination host. Responsive to an affirmative determination, the HW status manager causes the new workload to be submitted to a VF of a second HW accelerator of the destination host by incorporating information regarding the new workload within a migration stream associated with the live migration.

### TECHNICAL FIELD

Embodiments described herein generally relate to the field of virtual machine (VM) live migration from a source VM to a destination VM. More particularly, embodiments relate to an approach for avoiding the transfer of memory pages of the source VM dirtied by a workload making use of hardware accelerator virtualization that is received while performing live migration; and instead transferring the workload to the destination VM when the workload meets certain criteria.

### BACKGROUND

VM live migration is a technology that provides a running VM with the capability to be moved among different physical machines without disconnecting the client, for example, by migrating the states (e.g., of CPU, memory, storage, etc.) of a VM from one node (e.g., server) to another node. With the support of live migration, cloud service providers (CSPs) are able to achieve many benefits in the data center cloud. For infrastructure, live migration allows CSPs to achieve server network architecture optimization, cooling, and power management, for example, by gathering scattered tenants in different server clusters without comprising on commitments made in respective service-level-agreements (SLAs). For deployment, live migration enables CSPs to have more flexibility with respect to capacity planning, for example, facilitating adjustment of the number of the tenants in server clusters after a cluster is deployed. For resource management, live migration may be used by a CSP to achieve better resource utilization, which directly affects their bottom line. Also, live migration supports the CSP to achieve high availability and fault tolerance.

The process of live migration used in the cloud industry contains several stages, including:
Pre-copy. The purpose of this stage is to transfer the data and states as much as possible when the source VM is still alive so that there will be less data left to transfer in the next stage when both the source server and destination server are suspended. As the applications in the source VM are still running in this stage, the hypervisor (or virtual machine manager (VMM)) monitors the changes of the virtual states and keeps transferring them from the source server to the destination server. When the data to be copied lessens over time and appears to be converging, the VMM may transition from the pre-copy stage to the next stage.
Stop-and-copy. User applications will not respond at this stage because the source server and the destination server are both suspended. The rest of the virtual states are typically copied from the source to the destination as fast as possible during this stage as the time cost in this stage can heavily affect the SLA.
Post-copy (optional). Some VMMs support post-copy, which means that the destination server will start to run as long as the necessary data is transferred. The rest of the data transfer will continue in the background. If the destination touches memory or states that haven't been copied yet, the VMM will trap this event and copy it first.
Finish. The VM in the destination server is resumed and the VM in the source server is destroyed. At this point, the live migration is done.

Various performance metrics are used to evaluate live migration, including downtime, migration time, and success rate refers to the ratio of the number of successful live migrations to the total number of live migrations attempted over a particular period of time. Downtime refers to the amount of time during which the service of the VM is not available. Migration time refers to the total amount of time for transferring a VM from the source to the destination node.

With the rise of the use of hardware accelerators (e.g., graphics processing units (GPUs), artificial intelligence (AI) accelerators, field-programmable gate arrays (FPGAs)), hardware accelerator virtualization technology is now receiving more attention in the cloud market. A virtualization-friendly hardware accelerator is usually presented as a peripheral component interconnect (PCI) device with a number of PCI virtual functions (VFs). Each PCI VF is passed through into a VM for a given tenant that wishes to use the accelerator inside the VM machine. Specifically, in the context of hardware GPU virtualization, the GPU may expose multiple PCI VFs (which may be referred to herein individually as a GPU VF or collectively as GPU VFs). As in the general case above, each GPU VF will be passed to a VM for those tenants who purchase a GPU acceleration service from the CSP.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a block diagram conceptually illustrating VM live migration.

FIG. 2 is a block diagram illustrating VM live migration according to some embodiments.

FIG. 3 is a flow diagram illustrating high-level hardware status manager processing according to some embodiments.

FIG. 4 is a flow diagram illustrating a set of operations for handling workload submission during VM live migration according to some embodiments.

FIG. 5 is a block diagram conceptually illustrating a virtual function (VF) of a graphics processing unit (GPU).

FIG. 6 is a block diagram conceptually illustrating a format of a device state management region according to some embodiments.

FIG. 7 is a flow diagram illustrating a set of operations for processing device state management data received during VM live migration according to some embodiments.

FIG. 8 is an example of a computer system in which some embodiments may be employed.

### DETAILED DESCRIPTION

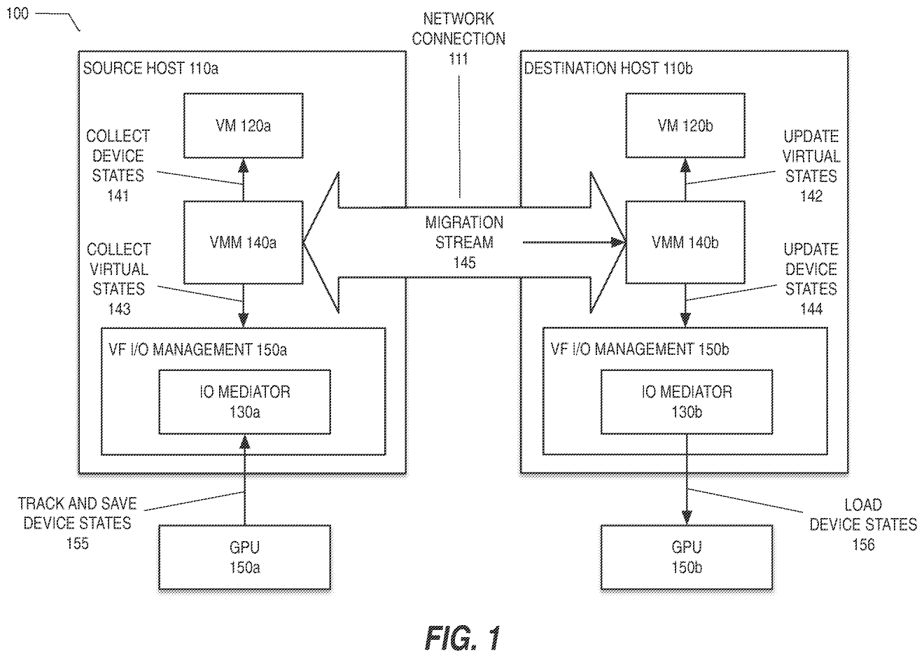

Embodiments described herein are generally directed to an improved workload submission handling strategy for workloads received during VM live migration and targeting VFs of a hardware accelerator. As an initial matter, a high-level overview of VM live migration is provided with reference to FIG. 1.

FIG. 1 is a block diagram conceptually illustrating VM live migration. In FIG. 1, a source host 110a and a destination host 110b run respective virtual machine monitors (VMMs) 140a and 140b that enable the creation, management, and governance of VMs (e.g., VM 120a and VM 120b). Source host 110a and destination host 110b represent the underlying hardware or physical host machine (e.g., a computer system or server) that provides computing resources (e.g., processing power, memory, disk, network input/output (I/O), and/or the like) that may be utilized by the VMs. Virtual function (VF) I/O management 150a and 150b is a framework or technology in the Linux kernel that exposes direct device access inside user space. IO mediators 130a and 130b represent vendor-specific plugins provided by or on behalf of the vendor of GPUs 150a and 150b, respectively. The IO mediators 130a and 130b are logically interposed between respective GPU VFs (not shown) exposed by GPUs 150a and 150b through the use of one of a number of technologies that allow the use of a GPU to accelerate graphics or general-purpose GPU (GPGPU) applications (or workloads) running on VMs 120a and 120b.

In the context of the present example, it is assumed a VM live migration is underway to migrate VM 120a or workloads running therein from to VM 120b. As part of the VM live migration, IO mediator 130a may track and save devices states 155 of GPU 150a (e.g., dirty pages) and VMM 140a may collect devices states 141 from VM 120a and may collect virtual states 143 from the VF I/O management framework 150a. The device states and virtual states collected on the source host 110a are transferred as part of the migration stream 145 via a network connection 111 between the source host 110a and the destination host 110b, thereby allowing VMM 140b to update VM 120b with virtual states 142 and cause the IO mediator 130b to load devices states 156 to GPU 150b by updating device states 144.

The VF I/O management frameworks 150a and 150b allow VMMs 140a and 140b to communicate with IO mediators 130a and 130b when they want to control a corresponding GPU VF, for example, pausing/unpausing the GPU VF, tracking the dirty pages of the GPU VF so that the VMM can pack them in to a VM live migration stream (e.g., migration stream 145) transmitted from the source host 110a to the destination host 110b. In this manner, the VMMs 140a and 140b may control the device states of a GPU VF, save and restore the device states of GPU VF, track the dirty page generated by the GPU VF on-the-fly by a workload during different stages of the live migration.

### Illustration of the Problem in the Context of a Concrete Video Streaming Example

Some GPU workloads (e.g., video decoding workloads) modify a lot of pages in the local and system memory. When such a workload is running in a VM during live migration, the CSP faces a number of challenges. For example, consider a tenant streaming video content via a video sharing website (e.g., YouTube) or collaborating/meeting online via a business communication platform (e.g., Microsoft Teams) with the configuration and input and output described below with reference to Table 1.

TABLE 1
Workload Configuration for Video Streaming

| Profile | Configuration | Input | Output |
|---|---|---|---|
| Ordinary | 1080P H264 | 8 megabits | YUV422 |
| Video | standard | per second | 1920 × 1080 × 2 × |
| Experience | dynamic range | Mbps/8 = 1 | 30/1024/1024 = 118 MB/s |
| | (SDR) 30 | megabyte | |
| | frames per | per second | |
| | second (fps) | (MB/s) | |
| Premium | 2160P H264 | 85 Mbps/8 = | YUV422 |
| Video | high dynamic | 17 MB/s | 3840 × 2160 × 2 × |
| Experience | range (HDR) | | 60/1024/1024 = 949 MB/s |
| | 60 fps | | |

Referring to Table 1 (above), in both the ordinary video experience and the premium video experience profile configurations, the memory pages will be modified continuously due to loading of the input bitstream (in this example, a bitstream in accordance with International telecommunication Union (ITU) Telecommunication Standardization Sector (ITU-T) H.264) and outputting the decoded YUV422 buffer. For the ordinary video experience profile, the dirty page rate will be at least 119 MB/s (i.e., 1 MB/s input+118 MB/s output). For the premium video experience profile, the dirty page rate will be at least 966 MB/s (17 MB/s input+949 MB/s output).

During the pre-copy stage of VM live migration, dirty pages should be transferred in a timely manner so that the remaining data will decrease over time to allow the VMM (e.g., VMM 140a) to move on to the next stage of VM live migration. In the stop-and-copy stage, the remaining data should be transferred as fast as possible because the source server (e.g., source host 110a) and the destination server (e.g., destination host 110b) are both suspended.

Due to the large number of dirty pages to be transferred during the VM live migration with a GPU workload running, achieving desired performance metrics becomes problematic. For example, suppose the downtime of live migration is committed as 16 milliseconds (ms) and the network infrastructure is 10 gigabit Ethernet (GbE), which is the most common network infrastructure utilized by CSPs at present and which can transmit data frames at a rate of 1.25 gigabytes per second (GB/s).

In the pre-copy stage, the network bandwidth can support both profiles (as 1.25 GB/s>118 MB/s and 966 MBs). In fact, for the ordinary video experience profile, the network bandwidth can support up to 10 tenants to be migrated at the same time. For the premium video experience profile, the network bandwidth can support migration of only 1 tenant at a time. In this example, the bandwidth is mostly occupied by the live migration bitstream, leaving only 200 MB/s left for other network traffic.

In the stop-and-copy stage, the worst case is just after a frame is decoded and outputted to the memory, the VM is paused. Thus, 966 MB (premium profile) or 118 MB (ordinary profile) dirty pages need to be transferred to the destination server in 16 ms. Optimistically, without any other traffic on the network, transferring 118 MB dirty pages in 10 GbE would take about 92 ms and 949 MB dirty pages would take about 741 ms. Assuming there is other traffic on the network, the situation will only get worse. As such, it should be appreciated it is impossible to achieve the SLA relating to downtime of 16 ms based on the example illustrated by Table 1.

Additionally, the large number of dirty pages creates huge pressure on the network infrastructure. If the network bandwidth is not always fully available to the live migration, for example, some other tenants are making use of the network bandwidth, the pre-copy stage may never converge, which will lead to failure of the live migration and affect the success rate. Furthermore, the network bandwidth utilized by the live migration is ultimately wasted due to the failure. The situation could become even worse if the administer keeps re-trying the live migration with the live migration failing each time.

Failing to achieve committed SLA may result in serious consequences for both customers and the CSP. For customers, a workload (e.g., cloud gaming, virtual reality, a live video broadcast, and the like) running inside the VM (e.g., VM 120a) might be sensitive regarding timing. As a result, failing to resume the VM (e.g., VM 120b) in the destination server on time will cause lag or screen tearing. In view of the fact that most television (TV) channels are building their live video broadcast infrastructure on the cloud, a screen tearing and/or lagging during a live news interview or other live event represents a serious issue.

For customers from industries that may heavily rely on GPU acceleration (e.g., in the medical imaging or security surveillance industries), failing to resume the VM on the destination server on time could have dire effects. For example, missing one important frame in a medical investigation may require the procedure to be repeated or may otherwise impact a diagnosis. For CSPs, SLA commitments represent a core factor evaluated by consumers when evaluating whether a CSP is worthy of being trusted with their latency and/or time-sensitive workloads. Failing to achieve SLA for critical customers can damage the reputation and market volume of a CSP in such a competitive market of cloud computing.

Both CSPs and GPU vendors have developed and/or proposed various solutions to attempt to address some of the challenges described above. For example, CSPs have proposed the use of a guest agent during the live migration involving GPU virtualization. The guest agent and other helpers may be integrated within a modified OS environment images to assist with live migration management. When live migration happens, the VMM sends a notification to the guest agent running inside the VM. The guest agent notices the modified service middleware are starts to throttle workload submissions from user applications. Instead of throttling workload submissions during live migration, some CSPs try to limit the CPU usage of the VM during the live migration. Meanwhile, some CSPs have updated their network infrastructure, for example, to 40 GbE.

For their part, HW vendors have attempted throttling workload submission from within the GPU firmware and/or from the GPU kernel-mode driver. In the case of the former, all workload submissions targeting a GPU VF are scheduled by the GPU firmware. In the case of the latter, when the VMM asks the GPU firmware to start to track dirty pages, the GPU firmware knows the pre-copy stage of the live migration has started. The firmware issues an interrupt through the GPU VF and when the GPU kernel-mode driver in the VM sees the interrupt, it starts to throttle the workload submissions.

These approaches suffer from various disadvantages. For example, while the approach of throttling workload submissions does indeed reduce the number of dirty pages, the throttling may negatively impact time-sensitive workloads running inside the VM. Meanwhile the use of a guest agent represents a security issue. Introducing a guest agent into the customers' environment has the effect of enlarging the attack surface as the guest agent is maintained by the CSP and also raises privacy concerns on the part of customers. With respect to throttling CPU usage, this can be even worse than throttling GPU workload submissions as it impacts other applications that are not using the GPU resources. Finally, although updating existing network infrastructure may not create noticeable technical side effects, it can be costly in terms of both budget and lost capacity during deployment of the new network.

In view of the foregoing, various embodiments described herein seek to provide, among other things, an improved workload submission handling strategy for workloads received during VM live migration and targeting VFs of a hardware accelerator. For example, as described further below, in one embodiment, while performing a live migration of a source VM running on a source host to a destination VM of a destination host during which a device model of the source host is transferring virtual device states and dirty memory pages to a device model of the destination host via a bitstream (e.g., a migration stream), a hardware (HW) status manager (e.g., in the form of a vendor-specific plugin) operable on the source host may identify a new workload targeting a VF of a first HW accelerator (e.g., a GPU VF) of the source host exposed by the source VM by trapping a workload submission channel through which HW accelerator workloads are submitted to the VF. Based on the nature of the new workload, the HW status manager may determine whether to transfer the new workload to the destination host. For example, the HW status manager may analyze the workload before submitting it to the local HW accelerator VF to determine whether it is a type of workload (e.g., a video decoding workload) that is expected to generate many dirty pages. Responsive to an affirmative determination, the HW status manager, may cause the new workload to be submitted to a VF of a second HW accelerator (e.g., a corresponding GPU VF) of the destination host that is exposed by the destination VM by incorporating information regarding the new workload within the bitstream. While the workload may be run concurrently in both the source VM and the destination VM, when the workload has been successfully executed, the HW status manager can bypass the transfer of the dirty pages created (which include the output of the workload) because the output will be present on the destination VM as a result of the execution of the workload by the VF of the second HW accelerator. In this manner, the copying of dirty pages for a large workload output may be bypassed by executing the workload in the destination instead of executing it in the source and transferring both the input and the output of the workload during the live migration.

Using the novel approach proposed herein for optimizing dirty page copy during live migration with HW accelerator virtualization significant bandwidth savings may be achieved. For instance, referring back to the workload configuration for video streaming example described above with reference to Table 1, assuming the workload was executed on the destination rather than transferring the dirty pages during live migration, for the ordinary video experience profile, 119 MB/s bandwidth per tenant can be saved. Similarly, for the premium video experience profile, 946 MB/s bandwidth per tenant can be saved. In a 10 GbE network infrastructure, 9% and 74% bandwidth per tenant can be saved during the live migration when a GPU workload is running in a VM.

Greatly reducing the dirty page copy of a GPU workload during live migration dramatically improves live migration performance metrics. Referring still to the workload configuration for video streaming example described above with reference to Table 1, 72 ms and 761 ms of downtime can be saved, respectively, for the ordinary video experience profile and the premium video experience profile by using the novel approach described herein. With respect to success rate, the proposed approach facilitates convergence during the pre-copy stage by reducing bandwidth requirements of live migration. For total migration time, the proposed approach provides improvements during each stage of live migration, thereby reducing the total migration time. For example, the proposed approach facilitates earlier and easier convergence during the pre-copy stage and as explained above, for the stop-and-copy stage, downtime can be reduced significantly.

While various examples herein are described with reference to the use of virtualized GPUs and GPU VF, the proposed methodologies are generally applicable to the virtualization of HW accelerators more generally.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.”

An “embodiment” is intended to refer to an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

As used herein “VM live migration” or simply “live migration” generally refers to the process of moving a running VM or application between different physical machines without disconnecting the client or application. For example, memory, storage, and network connectivity of a VM running on a source host may be transferred from the original guest machine to a VM running on a destination host.

As used herein a “device model” generally refers to a software mechanism through which configuration, states, and/or behavior of a specific target architecture device or family of devices may be modeled. A non-limiting example of a device model is Quick EUMulator (“QEMU”), which is a type 2 hypervisor for performing hardware virtualization. QEMU emulates a machine's processor through dynamic binary translation and provides a set of different hardware and device models for the machine, enabling it to run a variety of guest operating systems and run operating systems and programs for one machine on a different machine.

As used herein a “hardware accelerator” generally refers to a hardware device to which a CPU may offload certain computing tasks. Hardware accelerators may be peripheral component interconnect (PCI) or PCI express (PCIe) devices. Non-limiting examples of hardware accelerators include GPUs, AI accelerators, and FPGAs.

As used herein a “virtual function” or a “VF” generally refers to a predefined slice of physical resources of a hardware accelerator. VFs may appear as PCI devices, which are backed on the physical PCI device by physical resources (e.g., queues, register sets, engines, cores, memory) of the physical PCI device. There can be multiple VFs within a virtualized hardware accelerator that may be independently exposed for use by one or more VMs of a host system with which the hardware accelerator is associated. In this manner each of multiple VMs may be provided with its own dedicated share of physical resources of a virtualized hardware accelerator.

As used herein a “hardware status manager” generally refers to a vendor-specific plugin supplied by or on behalf a vendor of a hardware accelerator. A hardware status manager may be logically interposed between a particular VF exposed by a hardware accelerator (e.g., a GPU VF) and a VMM. A hardware status manager has knowledge about the hardware accelerator VF device and may be responsible for, among other things, facilitating collection and loading of device states from/to the hardware accelerator, trapping of a workload submission channel through which workloads are submitted to the particular VF to identify a workload being submitted to the particular VF, evaluating the nature of the workload, selectively injecting the workload into a migration stream when certain criteria are meet, and performing various other I/O operations with the hardware accelerator. In the context of a VFIO framework operable within the Linux OS, a non-limiting example of a hardware status manager is an IO mediator in which case the hardware status manager provides support for the generic VFIO application programming interfaces (APIs). However, embodiments described herein are not intended to be limited to the use of the VFIO framework are equally applicable to different mediated device frameworks that may be developed for the Linux OS and/or other OSs.

As used herein a “workload submission channel” generally refers to the mechanism by which a workload is submitted to a device. In the context of a GPU VF, a non-limiting example of a workload submission channel is a memory-based command communication channel between a VF kernel-mode driver (KMD) and the firmware microcontroller of the GPU in which writes to memory-mapped I/O (MMIO) registers associated with a VFIO region (e.g., the VF PCI base address register (BAR)) serve as an input mechanism to the firmware microcontroller.

### Example VM Live Migration

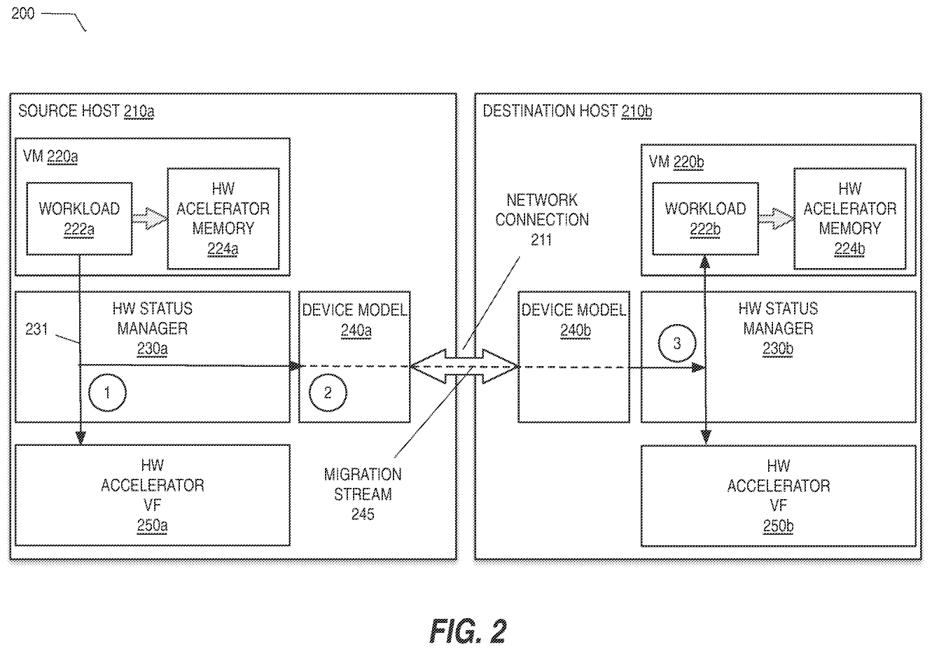

FIG. 2 is a block diagram illustrating VM live migration according to some embodiments. In the context of the present example, a source host 210a and a destination host 210b (which may be analogous to source host 110a and destination host 110a) run respective VMs 220a and 220b. The source host 210a and destination host 210b also include respective HW status managers 230a and 230b, respective device models 240a and 240b, and HW accelerator VFs 250a and 250b.

In one embodiment, HW status managers 230a and 230b represent vendor-specific plugins that facilitate interactions with corresponding VFs (e.g., HW accelerator VF 250a and 250b) of vendor supplied hardware accelerators (not shown). HW status managers 230a and 230b may be logically interposed between respective HW accelerator VFs 250a and 250b and device models 240a and 240b, respectively, to facilitate (i) collection of device state from HW accelerator VF 250a by device model 240a for transmission as part of the migration stream 245 to device model 240b and (ii) loading of device state to HW accelerator VF 250b by device model 240b, respectively. A non-limiting example of a HW status manager is an IO mediator with enhanced functionality to: (1) at the source, trap a workload submission channel 231 through which workloads are submitted to the corresponding VF (at circle #1); (2) inject the trapped workload into a migration stream 245 of a VM live migration (at circle #2); and (3) at the destination, selectively process device state management data received via the migration stream 245.

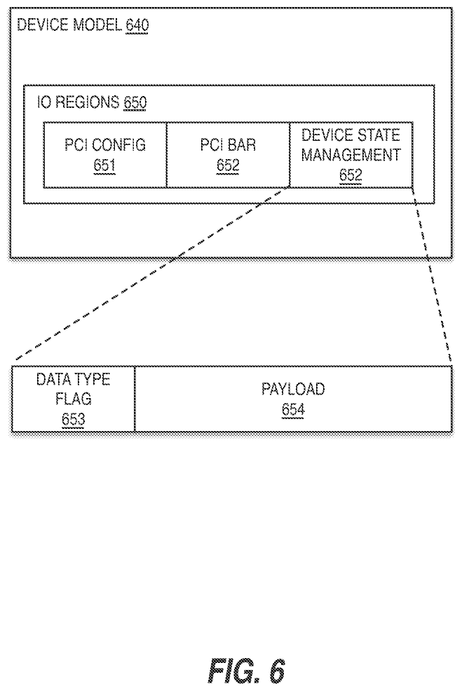

During VM live migration, device model 240a is responsible for, among other things, supporting a communication channel between HW status manager 230a and HW status manager 230b by packing (e.g., compressing) data supplied by HW status manager 230a into the migration stream 245 and transferring the migration stream 245 over a network connection 211 to device model 240b. For its part, device model 240b is responsible for, among other things, unpacking (e.g., decompressing) the migration stream 245 and saving and restoring the data belonging to HW status manager 230b from the migration stream 245. With this support, HW status manager 230a can cause the data (e.g., pages dirtied by a workload or the workload itself, as the case may be) to be transferred to HW status manager 230b to be stored within a particular IO region (e.g., a device state management region as depicted in FIG. 6). In response, device model 240a packs the data from the particular IO region into the migration stream 245 and transfers it to the destination host 210b. Upon receipt, device model 240b unpacks the data and writes it into a corresponding device state management region of the HW status manager 230b. A non-limiting example of device models 240a and 240b is QEMU, which may operate as a virtualizer in collaboration with virtualization technology (e.g., kernel-based virtual machines (KVM)) that turns the Linux OS into a hypervisor.

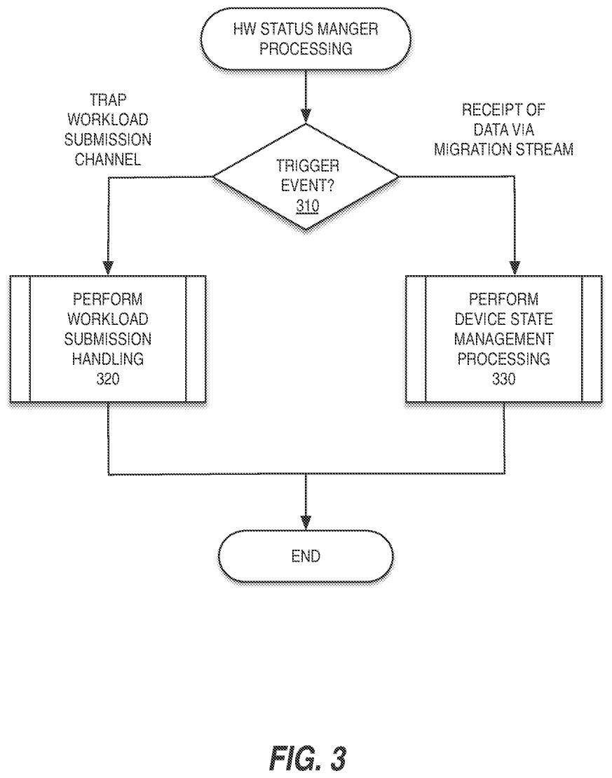

In the context of the present example, it is assumed a VM live migration is underway to migrate VM 120a or workloads running therein from to VM 120b. In the context of the present example and as described further below with reference to FIG. 3, when a workload 222a is submitted to HW accelerator VF 250a (e.g., a GPU VF) during the pre-copy stage of VM live migration via workload submission channel 231, HW status manager 230a is responsible for trapping the workload submission channel 231, analyzing the workload 222a, and causing it to be executed at the source and/or at the destination as appropriate so as to reduce bandwidth demands on the network connection 211 during the pre-copy stage. For example, when the workload 222a is one that is not expected to create many dirty pages within an output buffer 224a associated with the workload 222a, HW status manager 230a may simply allow the workload 222a to be executed locally and dirty pages created by the workload 222a will be transferred to the destination host 210b in accordance with traditional pre-copy stage VM live migration processing.

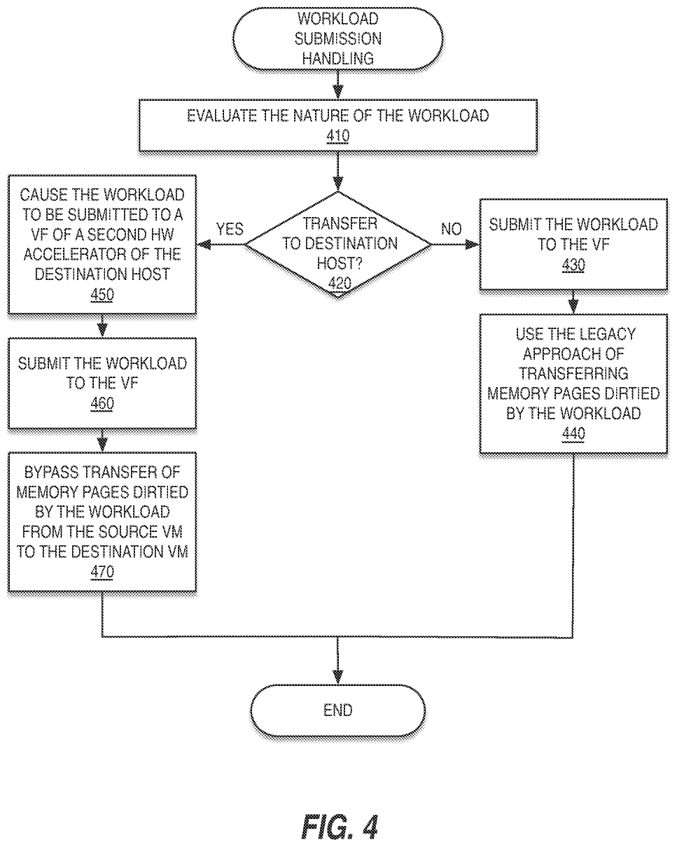

When the workload 222a, however, is one that is expected to create many dirty pages within the output buffer 224a, HW status manager 230a may cause the workload 222a to be executed in the form of workload 222b on VM 220b and be submitted to HW accelerator VF 250b by injecting the workload 222a into the migration stream 245 as described further below with reference to FIGS. 4 and 6. In this scenario, HW status manager 230a may also cause workload 222a to be run concurrently on VM 220a by submitting workload 222a to HW accelerator VF 250a. As described further below, because the output of workload 222b will be in output buffer 224b, the HW status manager 230a can bypass the transfer of the dirty pages created by workload 222a. In this manner, the copying of dirty pages for a workload expected to dirty pages at a high rate may be avoided by instead transferring the workload to the destination host 210b.

### Trapping the HW Accelerator VF Workload Submission

In one embodiment, when a VM live migration commences, the HW status manager (e.g., HW status manager 230a) operable at the source begins to monitor for workload submissions to a corresponding VF of a hardware accelerator (e.g., HW accelerator VF 250a). For example, this may involve trapping a workload submission channel (e.g., workload submission channel 231) through which workloads are submitted to a GPU VF. Assuming, for sake of illustration, the workload submission channel represents a memory-based command communication channel, to facilitate trapping of the command communication channel, prior to the VM live migration, the HW status manager may peek at the construction of the command communication channel, so that later the HW status manager will be able to trap the workload submission when live migration happens. For example, with the support of the VMM (e.g., device model 240a or VMM 140a), the HW status manager can trap the registering of the command communication channel from a VF KMD to a firmware microcontroller of the GPU, record its location and then register it through the GPU VF. As subsequent actions requested of the GPU microcontroller by the VF KMD will be via the now known command communication channel, workloads submitted to the GPU VF during VM live migration may be trapped by enabling monitoring of the workload submission channel when the live migration starts. While this example describes how to trap a GPU VF workload submission channel for a particular implementation, those skilled in the art will appreciate other combinations of drivers and hardware may be involved in other workload submission channel implementations.

### Example High-Level Hardware Status Manager Processing

FIG. 3 is a flow diagram illustrating high-level hardware status manager processing according to some embodiments. The processing described with reference to FIG. 3 may be performed by a HW status manger (e.g., HW status manager 230a or 230b) operable within a host (e.g., source host 210a or destination 210b) that is involved in a VM live migration. In an example, the HW status manager represents a vendor-specific plugin that may be used by a VMM (e.g., VMM 140a or 140b or device model 240a or 240b) to collect and load device states from/to a VF (e.g., HW accelerator VF 250a or 250b) of a hardware accelerator (e.g., GPU 150a or 150b) manufactured by the vendor.

At decision block 310, a determination is made regarding the trigger event that initiated the HW status manager processing at issue. When the trigger event represents a trap of a workload submission channel (e.g., workload submission channel 231), the HW status manager recognizes it is operating at the source of the VM live migration and continues with block 320; otherwise, when the trigger event represents receipt of data via a migration stream (e.g., migration stream 245), the HW status manager recognizes it is operating at the destination of the VM live migration and branches to block 330.

At block 320, the HW status manager performs workload submission handling. In one embodiment, based on the nature of a workload (e.g., workload 222a) submitted to the VF, the HW status manager selectively determines whether to transfer the workload to the destination for execution by the VF exposed to a VM (e.g., VM 220b). An example of workload submission handling is described further below with reference to FIG. 4.

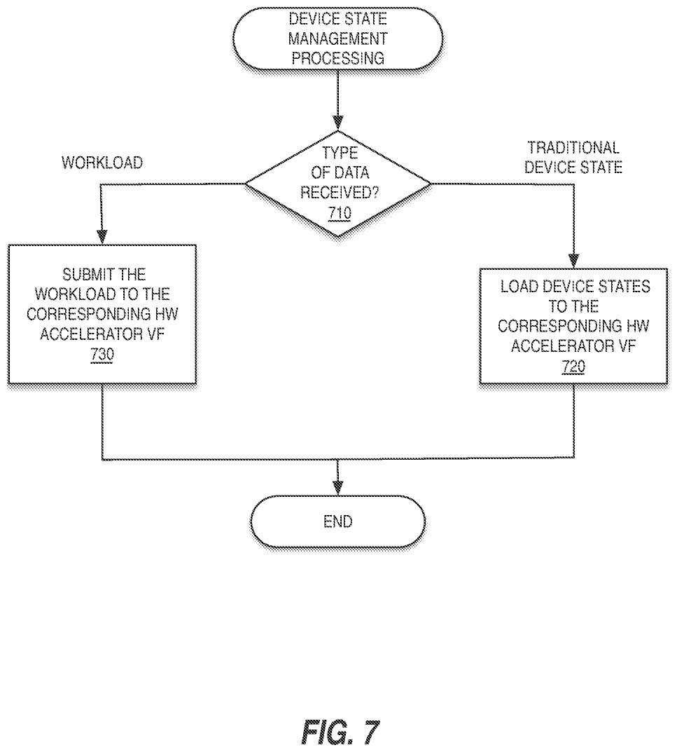

At block 330, the HW status manager performs device state management processing. In one embodiment, responsive to receipt of data via the migration stream from a peer HW status manager operable at the source, the HW status manager extracts device state management data unpacked by the VMM and stored to a particular IO region (e.g., a device state management region as depicted in FIG. 6) through which the peer HW status manager communicates with the HW status manager. An example of device state management processing is described further below with reference to FIG. 7.

### Example Workload Submission Handling at the Source

FIG. 4 is a flow diagram illustrating a set of operations for handling workload submission during VM live migration according to some embodiments. The processing described with reference to FIG. 4 may be performed by a HW status manger (e.g., HW status manager 230a) operable within a source host (e.g., source host 210a) during a VM live migration. FIG. 4 represents a non-limiting example of workload submission handling that may be performed at block 320 of FIG. 3. In the context of the present example, it is assumed the submission of a workload (e.g., workload 222a) to a VF (e.g., HW accelerator VF 250a) of a first virtualized hardware accelerator (e.g., GPU 150a) has been identified, for example, by trapping by the HW status manager, with support of a VMM (e.g., VMM 140a or device model 250a), a workload submission channel (e.g., workload submission channel 231).

At block 410, the HW status manager evaluates the nature of the workload. In one embodiment, the nature of the workload is indicative of a relative volume of memory pages expected to be dirtied as a result of performance of the workload. For example, a workload (a video decoding workload) that targets a VF that includes an engine of a GPU associated with video decoding functionality is presumed to create dirty pages at a relatively high rate, whereas a workload (a non-video decoding workload) that targets a VF that does not include an engine of a GPU associated with video decoding functionality is presumed to create dirty pages at a relatively lower rate than video decoding workloads.

At decision block 420, based on the nature of the workload determined in block 410, a determination is made regarding whether to transfer the workload to a destination host (e.g., destination host 210b) representing the destination of the VM live migration. If so, processing continues with block 450; otherwise processing branches to block 430.

In this example, blocks 430 and 440 represent a mode in which the HW status manager operates consistent with traditional pre-copy stage VM live migration processing. At block 430, the workload is submitted to the VF. For example, the workload is executed by a VM (e.g., VM 220a) in the source host making use of resources of the first virtualized hardware accelerator associated with the VF. At block 440, the legacy approach of transferring memory pages dirtied by the workload is employed. For example, the input to the workload and the dirty pages created by the workload within an output buffer (e.g., output buffer 224a) associated with the workload are transferred to the destination host in accordance with traditional pre-copy stage VM live migration processing.

In this example, blocks 450 to 470 represent a new mode in which the HW status manager seeks to reduce dirty page copying during the pre-copy stage. At block 450, the HW status manager causes the workload to be submitted to a VF (e.g., HW accelerator VF 250b) of a second virtualized hardware accelerator (e.g., GPU 150b) associated with the destination host. For example, the HW status manager may inject the workload into a migration stream (e.g., migration stream) of the VM live migration by causing the workload to be stored within a particular IO region (e.g., a device state management region as depicted in FIG. 6) representing a communication channel between the HW status manager and a peer HW status manager (e.g., HW status manager 230b) operable on the destination host.

At block 460, the workload is concurrently executed by a VM (e.g., VM 220a) in the source host making use of resources of the first virtualized hardware accelerator associated with the VF; however, pages dirtied by the workload in output buffer 224a will not be transferred to the destination host as noted below.

At block 470, the transfer from the source to the destination of memory pages dirtied by the workload is bypassed. In one embodiment, prior to submission of the workload to the VF in block 460, the HW status manager may determine the location of output buffer to which the results of the workload will be stored. Subsequently, during execution of the workload, the HW status manager may avoid marking these pages as dirty pages so as to preclude them from being transferred via the migration stream.

### Example Virtual Function of a Graphics Processing Unit

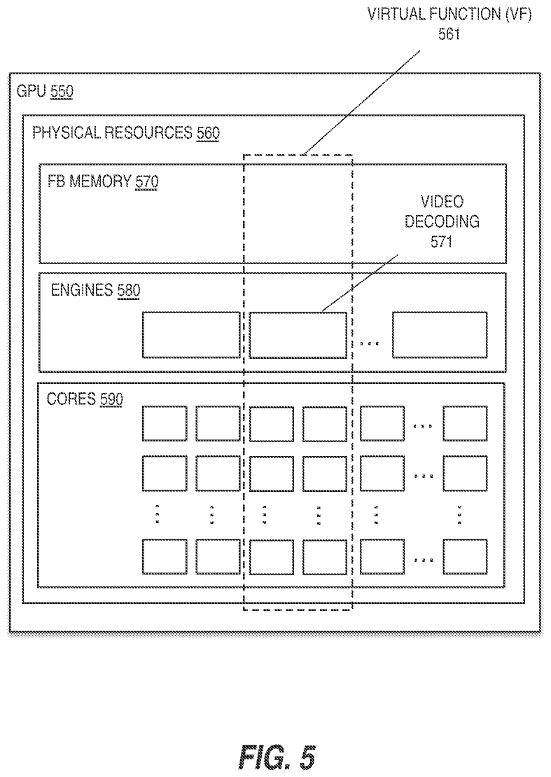

FIG. 5 is a block diagram conceptually illustrating a virtual function (VF) 561 of a graphics processing unit (GPU) 550. GPU 550 (which may be analogous to GPU 150a) is shown with physical resources 560, including a frame buffer (FB) memory 570, a number of engines 580 (such as a video decoding engine 571), and a number of cores 590.

In various examples described herein, a VF generally refers to a predefined slice of physical resources of a hardware accelerator. In the context of the present example, the predefined slice, VF 561 (which may be analogous to HW accelerator VF 250a or 250b), includes a portion of FB memory 570, video decoding engine 571, and some portion of cores 590. As noted above, in some examples, the nature of a workload being submitted to a VF of a virtualized hardware accelerator during VM live migration may be taken into consideration when making a dirty page copying optimization determination for the workload. For example, as described above with reference to FIG. 4, when the workload targets a VF, such as VF 561, that includes an engine of a GPU associated with video decoding functionality, the workload may be transferred to the destination of the VM live migration rather than copying dirty pages generated by the workload from the source of the VM live migration to the destination.

### Example Format of a Device State Management Region

FIG. 6 is a block diagram conceptually illustrating a format of a device state management region 652 according to some embodiments. Device model 640 (which may be analogous to device models 240a and 240b) is shown including a number of IO regions 650, which may represent VFIO regions when a VFIO framework is being employed, including a PCI configuration region 651, a PCI BAR region 652, and the device state management region 652. The PCI configuration region 651 and the PCI BAR region 652 may represent non-limiting examples of IO regions mapped to (associated with) MMIO registers of a hardware accelerator (e.g., GPU 150a) to facilitate the performance of I/O to/from the hardware accelerator.

The device state management region 652 may be used as a communication channel between peer HW status managers (e.g., HW status manager 230a and 230b) of a source and destination of a VM live migration. In the context of the present example, the device state management region 652 includes a data type flag 653 and a payload 654. In one embodiment, when the HW status manager operable at the source is transferring a workload (e.g., workload 222a) to the destination, the data type flag 653 may be set to a value indicating the payload 654 contains data representing the workload; otherwise, the data type flag 653 may be set to a value indicating the payload 654 contains data representing traditional device state information. In this manner, the HW status manager operable at the destination may process the data injected into the device state management region 652 and transferred via a migration stream (e.g., migration stream 245) accordingly based on the data type flag 653.

### Example Device State Management Data Processing at the Destination

FIG. 7 is a flow diagram illustrating a set of operations for processing device state management data received during VM live migration according to some embodiments.

The processing described with reference to FIG. 7 may be performed by a destination HW status manger (e.g., HW status manager 230b) operable within a destination host (e.g., destination host 210b) during a VM live migration. FIG. 7 represents a non-limiting example of device state management processing that may be performed at block 330 of FIG. 3. In the context of the present example, it is assumed data has been transmitted to the destination HW status manager by a source HW status manager (e.g., HW status manager 230a) operable within a source host (e.g., source host 210a) during the VM live migration. The data may represent traditional device state (e.g., including pages dirtied by one or more workloads running at the source) or may represent a workload (e.g., workload 222a). For example, as part of workload submission handling (e.g., the workload submission handling described above with reference to FIG. 4) performed by the source HW status manager, the submission of the workload targeting a VF (e.g., HW accelerator VF 250a) of a first virtualized hardware accelerator (e.g., GPU 150a) may have been trapped, the workload may have been identified as a type of workload (e.g., one that is expected to create dirty pages at a relatively high rate) that is to be transferred to the destination, and the source HW status manager may have injected the workload into a migration stream (e.g., migration stream 245) associated with the VM live migration.

At decision block 710, responsive to receipt of data within a device state management region (e.g., device management state region 652) via the migration stream, the destination HW status manager makes a determination regarding the type of data received within a payload (e.g., payload 654) of the device state management region. For example, the destination HW status manager may evaluate a data type flag (e.g., data type flag 663) contained within the device management state region. When the type of data received is determined to be representative of a workload being transferred from the source to the destination, the processing continues with block 730; otherwise, when the type of data received is determined to be representative of traditional device state, processing branches to block 720.

At block 720, the destination HW status manager may load the device states contained within the payload of the device state management region to the corresponding HW accelerator VF (e.g., HW accelerator VF 250b).

At block 730, the destination HW status manage may submit the workload contained within the payload of the device state management region to the corresponding HW accelerator VF.

While in the context of various example flow diagrams, a number of enumerated blocks are included, it is to be understood that the examples may include additional blocks before, after, and/or in between the enumerated blocks. Similarly, in some examples, one or more of the enumerated blocks may be omitted or performed in a different order.

### Example Computer System

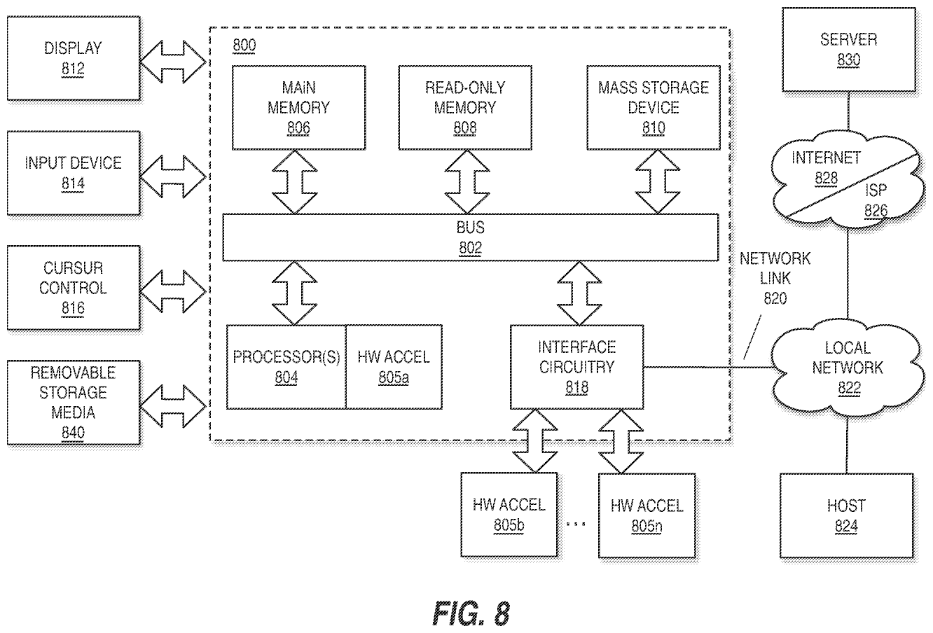

FIG. 8 is an example of a computer system 800 in which some embodiments may be employed. For example, computer system 800 may represent an example of a host (e.g., source host 110a or 210a or destination host 110a or 210b). Notably, components of computer system 800 described herein are meant only to exemplify various possibilities. In no way should example computer system 800 limit the scope of the present disclosure. In the context of the present example, computer system 800 includes a bus 802 or other communication mechanism for communicating information, and a processing resource (e.g., one or more hardware processors 804) coupled with bus 802 for processing information.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, e.g., a magnetic disk, optical disk or flash disk (made of flash memory chips), is provided and coupled to bus 802 for storing information and instructions.

Computer system 800 may be coupled via bus 802 to a display 812, e.g., a cathode ray tube (CRT), Liquid Crystal Display (LCD), Organic Light-Emitting Diode Display (OLED), Digital Light Processing Display (DLP) or the like, for displaying information to a computer user. An input device 814, including alphanumeric and other keys, is coupled to bus 802 for communicating information and command selections to processor 804. Another type of user input device is cursor control 816, such as a mouse, a trackball, a trackpad, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Removable storage media 840 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 800 may implement the techniques described herein using customized hard-wired logic, one or more ASICs or FPGAs, firmware or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 810. Volatile media includes dynamic memory, such as main memory 806. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes interface circuitry 818 coupled to bus 802. The interface circuitry 818 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 818 may couple the processing resource in communication with one or more discrete hardware accelerator devices (e.g., HW accel 805b-n). Alternatively or additionally computer system 800 may include one or more integrated hardware accelerator devices (e.g., HW accel 805a). HW accel devices 805a-n may be analogous to GPU 150a or 150b of FIG. 1.

Additionally or alternatively, interface 818 may also provide a two-way data communication coupling to a network link 820 that is connected to a local network 822. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN. Wireless links may also be implemented. In any such implementation, interface 818 may send and receive electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic or optical signals that carry digital data streams. The signals through the various networks and the signals on network link 820 and through interface 818, which carry the digital data to and from computer system 800, are example forms of transmission media.

Computer system 800 can send messages and receive data, including program code, through the network(s), network link 820 and interface 818. In the Internet example, a server 830 might transmit a requested code for an application program through Internet 828, ISP 826, local network 822 and interface 818. The received code may be executed by processor 804 as it is received, or stored in storage device 810, or other non-volatile storage for later execution.

Many of the methods may be described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that include a computer system comprising: a processor; a first hardware accelerator; and a machine-readable medium, coupled to the processor, having stored therein instructions, which when executed by the processor cause a hardware (HW) status manager to: while performing a live migration of a source virtual machine (VM) running on the computer system to a destination VM, identify a new workload targeting a virtual function (VF) of the first HW accelerator by trapping a workload submission channel through which HW accelerator workloads are submitted to the VF; based on a nature of the new workload, determining, whether to transfer the new workload to a destination host on which the destination VM is running; and responsive to an affirmative determination, causing the new workload to be submitted to a VF of a second HW accelerator of the destination host by incorporating information regarding the new workload within a migration stream of the live migration.

Example 2 includes the subject matter of Example 1, wherein the instructions further cause the HW status manager to responsive to the affirmative determination: cause the new workload to be concurrently performed by the source VM and the destination VM by submitting the new workload to the VF of the first HW accelerator; and bypass transfer from the source VM to the destination VM of memory pages of the source VM dirtied by the new workload.

Example 3 includes the subject matter of Examples 1-2, wherein the instructions further cause the HW status manager to responsive to a negative determination: cause the new workload to be performed by the source VM by submitting the new workload to the VF of the first HW accelerator; and transfer from the source VM to the destination VM memory pages of the source VM dirtied by the new workload.

Example 4 includes the subject matter of Examples 1-3, wherein the HW status manager comprises an input/output (I/O) mediator supplied by or on behalf of a vendor of the first HW accelerator that runs within a kernel of an operating system of the computer system.

Example 5 includes the subject matter of Examples 1-4, wherein the nature of the new workload is indicative of a relative volume of memory pages expected to be dirtied as a result of performance of the new workload.

Example 6 includes the subject matter of Examples 1-4, wherein the first HW accelerator comprises a graphics processing unit (GPU) and wherein the affirmative determination is as a result of the one or more resources of the VF targeted by the new workload including an engine of the GPU associated with video decoding functionality.

Example 7 includes the subject matter of Examples 1-6, wherein the information regarding the new workload is incorporated within a device state management region of the migration stream and wherein the device state management region includes a data type flag indicative of whether the device state management region contains the information regarding the new workload.

Some embodiments pertain to Example 8 that includes a non-transitory machine-readable medium storing instructions, representing a hardware (HW) status manager, which when executed by a processor of a source host cause the hardware (HW) status manage to: while performing a live migration of a source virtual machine (VM) running on the source host to a destination VM of a destination host, identify a new workload targeting a virtual function (VF) of a first HW accelerator of the source host by trapping a workload submission channel through which HW accelerator workloads are submitted to the VF; based on a nature of the new workload, determine whether to transfer the new workload to the destination host; and responsive to an affirmative determination, cause the new workload to be submitted to a VF of a second HW accelerator of the destination host by incorporating information regarding the new workload within a migration stream associated with the live migration.

Example 9 includes the subject matter of Example 8, wherein the instructions further cause the HW status manger to responsive to the affirmative determination: cause the new workload to be concurrently performed by the source VM and the destination VM by submitting the new workload to the VF of the first HW accelerator; and bypass transfer from the source VM to the destination VM of memory pages of the source VM dirtied by the new workload.

Example 10 includes the subject matter of Examples 8-9, wherein the instructions further cause the HW status manager to responsive to a negative determination: cause the new workload to be performed by the source VM by submitting the new workload to the VF of the first HW accelerator; and transfer from the source VM to the destination VM memory pages of the source VM dirtied by the new workload.

Example 11 includes the subject matter of Examples 8-10, wherein the HW status manager comprises an input/output (I/O) mediator supplied by or on behalf of a vendor of the first HW accelerator that runs within a kernel of an operating system of the source host.

Example 12 includes the subject matter of Examples 8-11, wherein the nature of the new workload is indicative of a relative volume of memory pages expected to be dirtied as a result of performance of the new workload.

Example 13 includes the subject matter of Examples 8-12, wherein the first HW accelerator comprises a graphics processing unit (GPU) and wherein the affirmative determination is as a result of the one or more resources of the VF targeted by the new workload including an engine of the GPU associated with video decoding functionality.

Example 14 includes the subject matter of Examples 8-13, wherein the information regarding the new workload is incorporated within a device state management region of the migration stream and wherein the device state management region includes a data type flag indicative of whether the device state management region contains the information regarding the new workload.

Some embodiments pertain to Example 15 that includes a method comprising: while performing a live migration of a source virtual machine (VM) running on a source host to a destination VM of a destination host, identifying, by a hardware (HW) status manager of the source host, a new workload targeting a virtual function (VF) of a first HW accelerator of the source host by trapping a workload submission channel through which HW accelerator workloads are submitted to the VF; based on a nature of the new workload, determining, by the HW status manager, whether to transfer the new workload to the destination host; and responsive to an affirmative determination, causing, by the HW status manager, the new workload to be submitted to a VF of a second HW accelerator of the destination host by incorporating information regarding the new workload within the migration stream associated with the live migration.

Example 16 includes the subject matter of Example 15, further comprising responsive to the affirmative determination: cause the new workload to be concurrently performed by the source VM and the destination VM by submitting, by the HW status manager, the new workload to the VF of the first HW accelerator; and bypassing transfer from the source VM to the destination VM of memory pages of the source VM dirtied by the new workload.

Example 17 includes the subject matter of Examples 15-16, wherein responsive to a negative determination: causing, by the HW status manager, the new workload to be performed by the source VM by submitting the new workload to the VF of the first HW accelerator; and transferring from the source VM to the destination VM memory pages of the source VM dirtied by the new workload.

Example 18 includes the subject matter of Examples 15-17, wherein the HW status manager comprises an input/output (I/O) mediator supplied by or on behalf of a vendor of the first HW accelerator that runs within a kernel of an operating system of the source host.

Example 19 includes the subject matter of Examples 15-18, wherein the nature of the new workload is indicative of a relative volume of memory pages expected to be dirtied as a result of performance of the new workload.

Example 20 includes the subject matter of Examples 15-19, wherein the first HW accelerator comprises a graphics processing unit (GPU) and wherein the affirmative determination is as a result of the one or more resources of the VF targeted by the new workload including an engine of the GPU associated with video decoding functionality.

Example 21 includes the subject matter of Examples 15-20, wherein the information regarding the new workload is incorporated within a device state management region of the migration stream and wherein the device state management region includes a data type flag indicative of whether the device state management region contains the information regarding the new workload.

Some embodiments pertain to Example 22 that includes an apparatus that implements or performs a method of any of Examples 15-21.

Some embodiments pertain to Example 23 includes an apparatus comprising means for performing a method as claimed in any of Examples 15-21.

Some embodiments pertain to Example 24 that includes at least one machine-readable medium comprising a plurality of instructions, when executed on a computing device, implement or perform a method or realize an apparatus as described in any preceding Example.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-21. (canceled)

22. A computer system comprising:
one or more processors;
a first hardware accelerator; and
a machine-readable medium, coupled to the one or more processors, having stored therein instructions, which when executed by the one or more processors cause a hardware (HW) status manager to:
while performing a live migration of a source virtual machine (VM) running on the computer system to a destination VM, identify a new workload targeting a virtual function (VF) of the first HW accelerator by trapping a workload submission channel through which HW accelerator workloads are submitted to the VF;
based on a nature of the new workload, determining, whether to transfer the new workload to a destination host on which the destination VM is running; and
after an affirmative determination, causing the new workload to be submitted to a VF of a second HW accelerator of the destination host by incorporating information regarding the new workload within a migration stream of the live migration.

23. The computer system of claim 22, wherein, after the affirmative determination, the instructions further cause the HW status manager to:
cause the new workload to be concurrently performed by the source VM and the destination VM by submitting the new workload to the VF of the first HW accelerator; and
bypass transfer from the source VM to the destination VM of memory pages of the source VM dirtied by the new workload.

24. The computer system of claim 22, wherein, after a negative determination, the instructions further cause the HW status manager to:
cause the new workload to be performed by the source VM by submitting the new workload to the VF of the first HW accelerator; and
transfer from the source VM to the destination VM memory pages of the source VM dirtied by the new workload.

25. The computer system of claim 22, wherein the HW status manager comprises an input/output (I/O) mediator supplied by or on behalf of a vendor of the first HW accelerator that runs within a kernel of an operating system of the computer system.

26. The computer system of claim 22, wherein the nature of the new workload is indicative of a relative volume of memory pages expected to be dirtied as a result of performance of the new workload.

27. The computer system of claim 22, wherein the first HW accelerator comprises a graphics processing unit (GPU) and wherein the affirmative determination is as a result of one or more resources of the VF targeted by the new workload including an engine of the GPU associated with video decoding functionality.

28. The computer system of claim 22, wherein the information regarding the new workload is incorporated within a device state management region of the migration stream and wherein the device state management region includes a data type flag indicative of whether the device state management region contains the information regarding the new workload.

29. A non-transitory machine-readable medium storing instructions, representing a hardware (HW) status manager, which when executed by one or more processors of a source host cause the hardware (HW) status manage to:
while performing a live migration of a source virtual machine (VM) running on the source host to a destination VM of a destination host, identify a new workload targeting a virtual function (VF) of a first HW accelerator of the source host by trapping a workload submission channel through which HW accelerator workloads are submitted to the VF;
based on a nature of the new workload, determine whether to transfer the new workload to the destination host; and
after an affirmative determination, cause the new workload to be submitted to a VF of a second HW accelerator of the destination host by incorporating information regarding the new workload within a migration stream associated with the live migration.

30. The non-transitory machine-readable medium of claim 29, wherein, after the affirmative determination, the instructions further cause the HW status manger to:
cause the new workload to be concurrently performed by the source VM and the destination VM by submitting the new workload to the VF of the first HW accelerator; and
bypass transfer from the source VM to the destination VM of memory pages of the source VM dirtied by the new workload.

31. The non-transitory machine-readable medium of claim 29, wherein, after a negative determination, the instructions further cause the HW status manager to:
cause the new workload to be performed by the source VM by submitting the new workload to the VF of the first HW accelerator; and
transfer from the source VM to the destination VM memory pages of the source VM dirtied by the new workload.

32. The non-transitory machine-readable medium of claim 29, wherein the HW status manager comprises an input/output (I/O) mediator supplied by or on behalf of a vendor of the first HW accelerator that runs within a kernel of an operating system of the source host.

33. The non-transitory machine-readable medium of claim 29, wherein the nature of the new workload is indicative of a relative volume of memory pages expected to be dirtied as a result of performance of the new workload.

34. The non-transitory machine-readable medium of claim 29, wherein the first HW accelerator comprises a graphics processing unit (GPU) and wherein the affirmative determination is as a result of one or more resources of the VF targeted by the new workload including an engine of the GPU associated with video decoding functionality.

35. The non-transitory machine-readable medium of claim 29, wherein the information regarding the new workload is incorporated within a device state management region of the migration stream and wherein the device state management region includes a data type flag indicative of whether the device state management region contains the information regarding the new workload.

36. A method comprising:
while performing a live migration of a source virtual machine (VM) running on a source host to a destination VM of a destination host, identifying, by a hardware (HW) status manager of the source host, a new workload targeting a virtual function (VF) of a first HW accelerator of the source host by trapping a workload submission channel through which HW accelerator workloads are submitted to the VF;
based on a nature of the new workload, determining, by the HW status manager, to transfer the new workload to a destination host on which the destination VM is running; and
causing the new workload to be submitted to a VF of a second HW accelerator of the destination host by incorporating information regarding the new workload within a migration stream of the live migration.

37. The method of claim 36, further comprising:
causing the new workload to be concurrently performed by the source VM and the destination VM by submitting, by the HW status manager, the new workload to the VF of the first HW accelerator; and
bypassing transfer from the source VM to the destination VM of memory pages of the source VM dirtied by the new workload.

38. The method of claim 36, wherein the HW status manager comprises an input/output (I/O) mediator supplied by or on behalf of a vendor of the first HW accelerator that runs within a kernel of an operating system of the source host.

39. The method of claim 36, wherein the nature of the new workload is indicative of a relative volume of memory pages expected to be dirtied as a result of performance of the new workload.

40. The method of claim 36, wherein the first HW accelerator comprises a graphics processing unit (GPU) and wherein said determining is as a result of one or more resources of the VF targeted by the new workload including an engine of the GPU associated with video decoding functionality.

41. The method of claim 36, wherein the information regarding the new workload is incorporated within a device state management region of the migration stream and wherein the device state management region includes a data type flag indicative of whether the device state management region contains the information regarding the new workload.
